(19) United States
(12) Patent Application Publication
(10) Pub. No.: US 2011/0308301 A1
(43) Pub. Date: Dec. 22, 2011

(54) LEAK DETECTION SYSTEM

(76) Inventor: JAMES GLOVER, Elk Grove Village, IL (US)

(21) Appl. No.: 13/150,453

(22) Filed: Jun. 1, 2011

Related U.S. Application Data
(60) Provisional application No. 61/355,347, filed on Jun. 16, 2010.

(51) Int. Cl. G01M 3/20

(52) U.S. Cl. 73/40.7

(57) ABSTRACT

A supersonic tracer gas impingement through-wall leak detection system can detect leaks through a barrier without the need for temporary enclosures or interior pressurization. The leak detection system includes a wand that can flow a mixture of compressed gas, such as air, and a tracer gas through a nozzle. The nozzle may be held close to a barrier to be tested and the pressure supplied against the barrier may be adjusted to achieve the desired exit velocity and resulting stagnation pressure on the surface of the tested barrier. A tracer gas detector or soap solution for visual indication of bubbling can be disposed on the other side of the barrier to detect the presence or absence of the tracer gas.

### CROSS-REFERENCE TO RELATED APPLICATIONS

The present application claims the benefit of priority of U.S. provisional patent application No. 61/355,347, filed Jun. 16, 2010, the contents of which are herein incorporated by reference.

### BACKGROUND OF THE INVENTION

The present invention relates to leak detection systems and methods, and more particularly, to a through-wall, supersonic tracer gas impingement leak detection system and method.

Often, conventional barriers cannot be easily enclosed to allow for pressurization in order to detect gaseous leaks through the barrier. Such barriers are usually laboriously temporarily encloses, or, in cases where the barriers are integral to a containment structure, the entire structure's interior may need to be pressurized to check for local through-wall leakage. For example, containment liners, walls, flexible metal bellows and other barriers, such as those in nuclear power plant containment building and components, require testing according to various rules and regulations, such as 10 CFR 50 Appendix J, and, in some cases, ASME section XI.

As can be seen, there is a need for systems and methods for through-wall leakage detection without the need for temporary enclosures or interior pressurization.

### SUMMARY OF THE INVENTION

In one aspect of the present invention, a leak detection system comprises a nozzle adapted to deliver a mixture of compressed gas and a tracer gas to a first side of a barrier to be tested for leaks; and a tracer gas detector or soap solution for visual indication of bubbling located on a second, opposite side of the barrier to be tested.

In another aspect of the present invention, a method for detecting leaks in a barrier comprises delivering a gas stream toward a first side of the barrier to create a desired pressure of the gas stream on the barrier, wherein the gas stream includes a tracer gas and a carrier gas; and detecting the presence or absence of the tracer gas on a second, opposite side of the barrier with a tracer gas detector or soap solution for visual indication of bubbling.

These and other features, aspects and advantages of the present invention will become better understood with reference to the following drawings, description and claims.

### BRIEF DESCRIPTION OF THE DRAWINGS

FIG. 1 is a schematic view of a leakage detection system according to an exemplary embodiment of the present invention; and

FIG. 2 is a cross-sectional view of a nozzle of the leak detection system of FIG. 1 in use to detect leaks through a barrier.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a supersonic tracer gas impingement through-wall leak detection system that can detect leaks through a barrier without the need for temporary enclosures or interior pressurization. The leak detection system includes a wand that can flow a mixture of compressed gas, such as air, and a tracer gas through a nozzle. The nozzle may be held close to a barrier to be tested and the pressure supplied against the barrier may be adjusted to achieve the desired exit velocity and resulting stagnation pressure on the surface of the tested barrier. A tracer gas detector or soap solution for visual indication of bubbling can be disposed on the other side of the barrier to detect the presence or absence of the tracer gas.

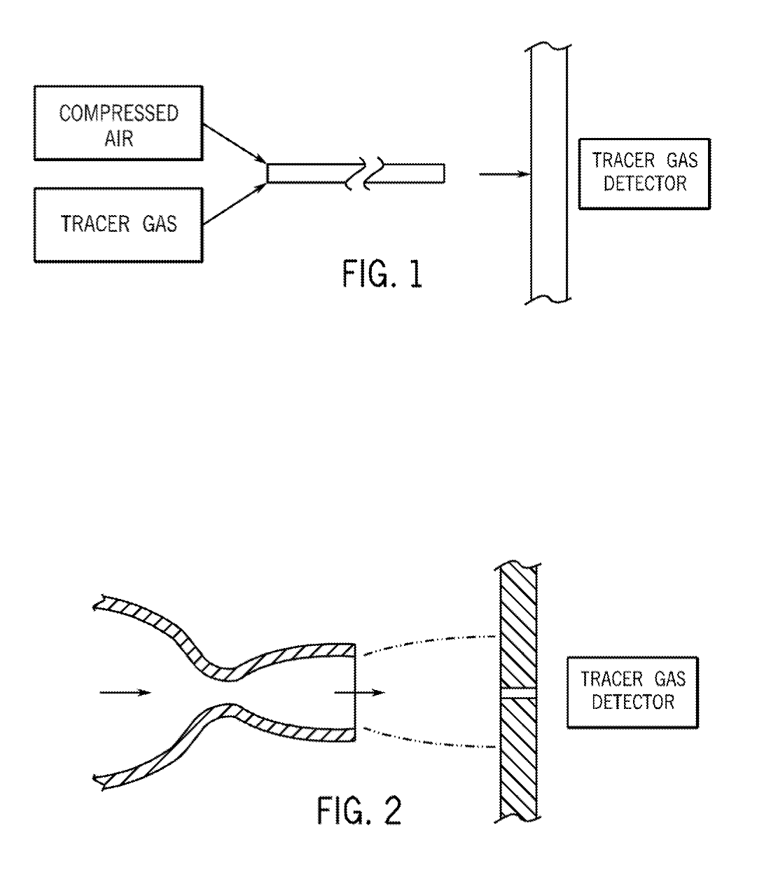

Referring to FIGS. 1 and 2, an exemplary embodiment of the system may include of a wand that can flow a mixture of a carrier gas, typically a compressed gas, and tracer gas though a converging/diverging nozzle. The compressed gas may be, for example, air. The tracer gas may be, for example Helium or Halon. Of course, any compressed gas compatible with the barrier being tested may be used. Similarly, any tracer gas capable of being detected by a tracer gas detector or soap solution for visual indication of bubbling may be used.

The discharge of this nozzle may be a supersonic jet of gas that can be directed toward and held close to one side of the barrier to be leak tested. The nozzle may be sized depending on the particular application. Typically, the nozzle may have an initial opening that converges to a converged size sufficiently small to choke the flow. The nozzle may then diverge to a size sufficient to ensure the required super-sonic velocity. Typical nozzle inlet size will range from 0.5 inches to 3 inches. Typically, the nozzle may be held from about 0.1 inches to about 2 inches from the barrier.

The inlet pressure to the nozzle can be adjusted to achieve the desired exit velocity and resulting stagnation pressure on the surface of the tested barrier. On the opposite side of the barrier, a tracer gas detector or soap solution for visual indication of bubbling can sample the atmosphere. Any though-wall leakage can be detected by the detector. A pressure sensitive coating may be used to coat the barrier's surface on the wand side of the wall. This can provide visual indication of the specific areas of the barrier subjected to the required test pressure.

The wand may be track mounted, which can ensure methodical full coverage of the surface to be tested. A track-mounted wand can also minimize the physical stress of holding the pressurized wand for long periods of time.

The supersonic jet may be directed orthogonally to the surface being tested. When the jet impinges with the surface, the velocity is converted to pressure. This scheme can allow for portions of the surface of the barrier being tested to be subjected to a leak test at a specified test pressure without the need for enclosure. If any through-wall leakage exists, it may be detected by the tracer gas leak detector on the other side of the wall.

The leak detection system can work by generating a supersonic jet of air doped with a tracer gas, which may be directed against the surface to be leak tested. When this jet impinges against the wall, the supersonic air velocity can change to zero axial velocity and high pressure over a small area, typically from about 0.25 inches to about 3 inches wide. The pressure generated may be controlled by controlling the velocity of the jet. The velocity of the jet can in turn be controlled by controlling the inlet air pressure, which can allow for the surface to be subjected to specified required test pressures without the need for an enclosure.

The tracer gas in the air jet and tracer gas detector or soap solution for visual indication of bubbling located behind the wall can allow for the detection of leakage through the wall while it is subjected to the required test pressure.

It should be understood, of course, that the foregoing relates to exemplary embodiments of the invention and that modifications may be made without departing from the spirit and scope of the invention as set forth in the following claims.

What is claimed is:

1. A leak detection system comprising:
a nozzle adapted to deliver a mixture of compressed gas and a tracer gas to a first side of a barrier to be tested for leaks; and
a tracer gas detector or soap solution for visual indication of bubbling located on a second, opposite side of the barrier to be tested.

2. The leak detection system of claim 1, wherein a diameter of the nozzle converges and diverges prior to delivering the mixture to the first side of the barrier.

3. The leak detection system of claim 1, wherein the compressed gas is air.

4. The leak detection system of claim 1, wherein the tracer gas is Helium or Halon.

5. The leak detection system of claim 2, wherein the nozzle converges to a converged size from about 5 to about 30% of its diameter prior to converging.

6. The leak detection system of claim 5, wherein the nozzle diverges to about 1.1 to about 10 times the converged size.

7. A method for detecting leaks in a barrier comprising:
delivering a gas stream toward a first side of the barrier to create a desired pressure of the gas stream on the barrier, wherein the gas stream includes a tracer gas and a carrier gas; and
detecting the presence or absence of the tracer gas on a second, opposite side of the barrier with a tracer gas detector or soap solution for visual indication of bubbling.

8. The method of claim 7, further comprising delivering the gas stream orthogonally toward the first side of the barrier.

9. The method of claim 7, further comprising converging and diverging the gas stream through a nozzle prior to delivering the gas stream toward the first side of the barrier.

10. The method of claim 7, further comprising adjusting an inlet pressure of the carrier gas to achieve the desired pressure.
